(19) United States
(12) Patent Application Publication
(10) Pub. No.: US 2008/0047359 A1
(43) Pub. Date: Feb. 28, 2008

(54) A digital gas flowmeter (DigiFlux™) using hall effect gas sensor for medical/science use

(76) Inventors: Yang Zheng, Beijing (CN); Timothy Michael Wilkerson, Beijing (CN); Shu Zheng, Beijing (CN)

Correspondence Address: Zheng Yang, 25-1-502,LongYueYuan1, Changping District, Beijing, 102208, omitted

(21) Appl. No.: 11/467,173

(22) Filed: Aug. 25, 2006

(51) Int. Cl. G01F 1/22

(52) U.S. Cl. 73/861.53

(57) ABSTRACT

This DigiFlux™ digital gas flow sensor (DigiFlux™) can measure the gas flow by its Hall effect gas sensor. DigiFlux™ [FIG. 1] is based on the Hall effect. In DigiFlux™, an air-float with a small magnetic-iron attached to its bottom, is upright on a Hall effect sensor made by a conductor with I/O connector. When the air-float moves up or down caused by the gas influx pressure, the magnetic-iron in the bottom of air-float will cause electromagnetic sense, and will generate Hall voltage (Vh) signal on Hall effect sensor. The Vh signal will be sent to amplifier then to the MCU/DSP for analog-to-digital conversion, then the gas influx flow will be sensed as digital signal and can be processed by MCU/DSP. Based on functional program one can set different modes to measure gas flow. DigiFlux™ can measure gas flow with high-precision even with a small influx of gas.

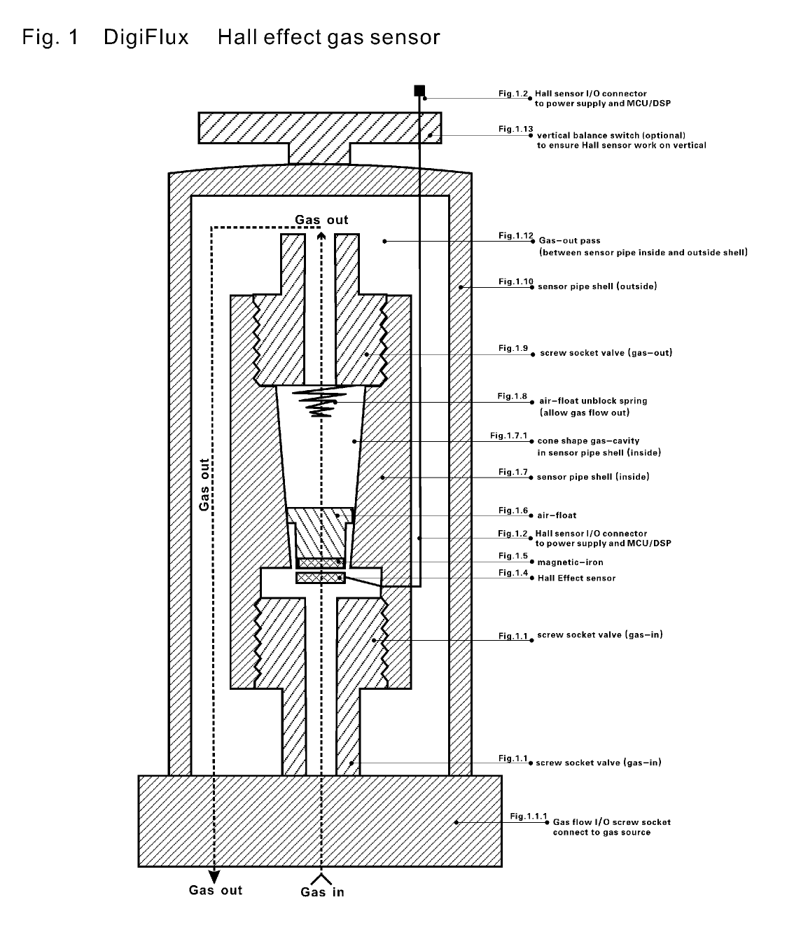

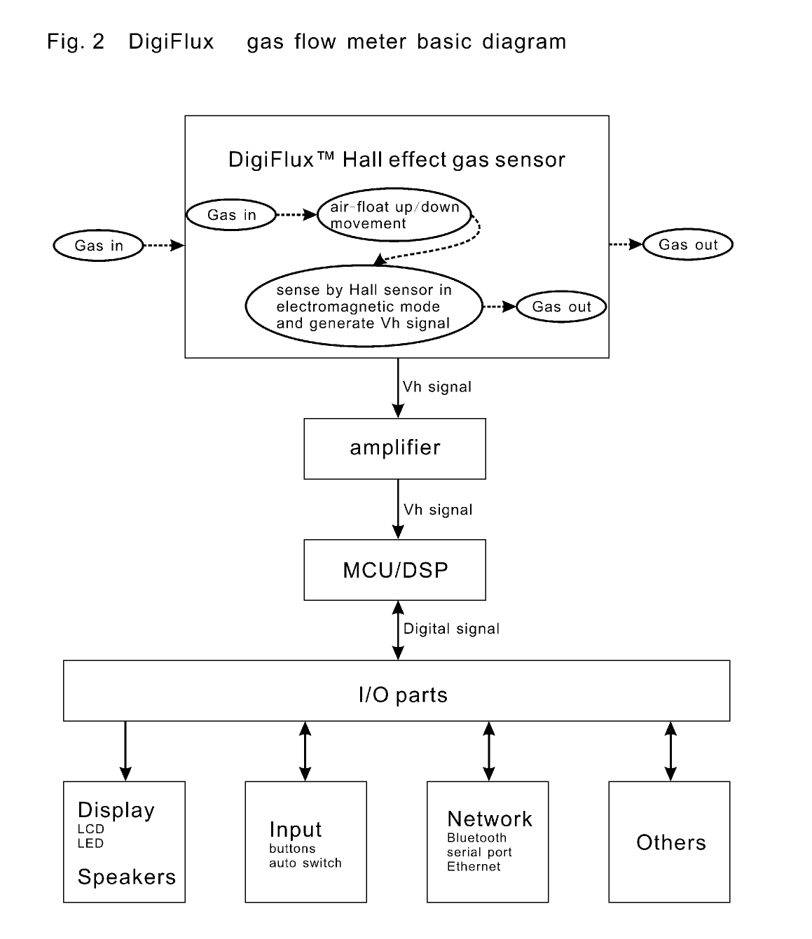

This device measures gas usage such as oxygen or hydrogen through the DigiFlux™ Hall effect gas sensor which will convert the movement of the air-float [FIG. 1.6] in the DigiFlux™ Hall effect gas sensor [FIG. 1] into Hall voltage (Vh) signal by electromagnetic sense, then convert to a digital signal, which is then processed by a functional programmed MCU/DSP (Micro Control Unit/Digital Signal Processor) which then measures gas usage [FIG. 2]. Gas originating from a source such as an oxygen pressurized tank, enters device.

DigiFlux™ Hall effect gas sensor [FIG. 1] is based on the Hall effect, which if an electric current flows through a conductor in a magnetic field, the magnetic field exerts a transverse force on the moving charge carriers which tends to push them to one side of the conductor. This is most evident in a thin flat conductor as illustrated. A buildup of charge at the sides of the conductors will balance this magnetic influence, producing a measurable voltage (Vh) between the two sides of the conductor. The presence of this measurable transverse voltage (Vh) is called the Hall effect after E. H. Hall who discovered it in 1879. In DigiFlux™ Hall effect gas sensor [FIG. 1], the air-float [FIG. 1.6] bottom is attached with a small magnetic-iron [FIG. 1.5], and is upright on a Hall effect sensor [FIG. 1.4] made by a conductor with I/O connector [FIG. 1.2] and includes a power supply and Hall voltage (Vh) signal sensor socket.

The air-float [FIG. 1.6] senses the influx of gas by the pressure of the gas which moves the air-float [FIG. 1.6]. A start signal sent by sensor to the MCU/DSP [FIG. 2] begins calculating gas usage. When the gas stops, the MCU/DSP will stop calculating and save the result record to the memory on the MCU/DSP, then output the result record to the LCD display screen [FIG. 2] on the device.

Gas enters valve (gas-in) [FIG. 1] installed on a gas flow I/O screw socket [FIG. 1.1.1] which is connected with gas source. When gas passes valve (gas-in) [FIG. 1.1], gas will flow up and against the air-float [FIG. 1.6] and cause it certain movement. Hall effect sensor [FIG. 1.4] will sense the air-float movement by electromagnetic sense, and generate Hall voltage (Vh) signal. Gas will flow and bypass the air-float [FIG. 1.6] then out from valve (gas-out) [FIG. 1.9]. To prevent the air-float [FIG. 1.6] from blocking the valve (gas-out) [FIG. 1.9], an air-float unblock spring [FIG. 1.8] is installed on valve (gas-out) [FIG. 1.9]. Then gas will flow out by Gas-out pass [FIG. 1.12] between this sensor inside shell [FIG. 1.7] and outside shell [FIG. 1.10], finally, gas will through Gas flow I/O screw socket [FIG. 1.1.1] out to use.

The DigiFlux™ Hall effect gas sensor works better when it is on vertical status and therefore a vertical balance switch [FIG. 1.13] is installed on the top of sensor pipe shell (out-side) [FIG. 1.10], which can warn MCU/DSP of non-vertical status of DigiFlux™ Hall effect gas sensor.

The Hall voltage (Vh) signal from Hall effect sensor [FIG. 1.4] will be amplified [FIG. 2], then converted to digital signal by the MCU/DSP [FIG. 2]. The calculation in the MCU/DSP will be based on a specially designed program by manufacturer. This device can be modified to customized functions, such as flow-mode, timer-mode, total-usage-mode, among others.

The entire DigiFlux™ Hall effect gas sensor is made by High-Pressure-Stand material such as engineering plastics (medical use PVC), which allows the gas to be able to be mixed with medicine and with high pressure from the gas source.

DigiFlux™ Hall effect gas sensor's Gas flow I/O screw socket [FIG. 1.1.1] can be modified to fit on different standard socket connectors for gas source, such as medical use oxygen tank.

If there is any unexpected stoppage in gas supply, the MCU/DSP will, based on the program, warn by alarm. This device can share the data with a central computer in a network. The network can use Bluetooth, Serial port, or Ethernet. This device can be modified for changes in network protocol as the network improves.

What is claimed is:

1. A digital flowmeter comprising: a DigiFlux™ Hall effect gas sensor, installed with an air-float [FIG. 1.6] bottom with magnetic-iron [FIG. 1.5], the air-float [FIG. 1.6] is in upright position on a Hall effect sensor [FIG. 1.4], and in a cone shape gas-cavity [FIG. 1.7.1] in the piped style shell [FIG. 1.7]. The function of the DigiFlux™ Hall effect gas sensor: Gas enters valve (gas-in) [FIG. 1.1] installed on a gas flow I/O screw socket [FIG. 1.1.1] which is connected with gas source. When gas passes valve (gas-in) [FIG. 1.1], gas will flow up and against the air-float [FIG. 1.6] and cause it certain movement. Hall effect sensor [FIG. 1.4] will sense the air-float movement by electromagnetic sense, and generate Hall voltage (Vh) signal. A change in the gas-in flow pressure will cause air-float movement which is sensed by Hall effect sensor, which changes the Vh signal output. Gas will flow and bypass the air-float [FIG. 1.6] then out from valve (gas-out) [FIG. 1.9]. To prevent the air-float [FIG. 1.6] from blocking the valve (gas-out) [FIG. 1.9], an air-float unblock spring [FIG. 1.8] is installed on valve (gas-out) [FIG. 1.9]. Then, gas will flow out through Gas-out pass [FIG. 1.12] between this sensor inside shell [FIG. 1.7] and outside shell [FIG. 1.10], then gas out from Gas flow I/O screw socket [FIG. 1.1] to use; The Hall effect sensor generates Hall voltage (Vh) signal by the movement of the air-float, and this Vh signal will be amplified by the inside amplifier in this DigiFlux™ digital gas flow meter device, and will send this amplified signal to the MCU/DSP; the signal processed by MCU/DSP is then outputted as result command data to other I/O parts, such as LCD display device, speaker, network part, etc. MCU/DSP converts the Vh signal to digital signal by its built-in A/D converter, then this digital signal within the MCU/DSP can be programmed for data processing; a gas-in signal can be a start command to MCU/DSP to start calculating.

2. Based on claim 1, a cone shape gas-cavity [FIG. 1.7.1] in the pipe shell [FIG. 1.7] is the space for air-float [FIG. 1.6] to be placed; diameter of air-float [FIG. 1.6] should be bigger than down pass of the cone shape gas-cavity [FIG. 1.7.1]; when air-float [FIG. 1.6] is in start position, the air-float can block the cone shape gas-cavity and is upright on the Hall effect sensor [FIG. 1.4].

3. Based on claim 1 and 2, this device sensor [FIG. 1] uses Hall effect to sense gas flow; the movement of air-float [FIG. 1.6] caused by gas flow will generate Vh signal from Hall effect sensor [FIG. 1.4] to sense and to process.

4. Based on claim 3, the air-float [FIG. 1.6] bottom is installed with a small magnetic-iron, which interacts with the Hall effect sensor [FIG. 1.4] which generates Vh signal.

5. Based on Claims from 1 to 4, the DigiFlux™ Hall effect gas sensor is made with High-Pressure-Stand material such as engineering plastics (medical use PVC), which allows the gas to be able to be mixed with medicine and with high pressure from the gas source.

6. The onboard programmable MCU/DSP can process the signal from the Hall-Sensor in certain modes programmed by Manufacturer to reach the needs for customized functions for clients. A programmable display device such as LCD screen connects to the MCU/DSP to display the result data from MCU/DSP.

7. Other I/O device can be optionally installed on the flow meter, such as network part, speakers, and buttons; network part's function is to link a network and share the data of this device with other devices, such as a computer; speakers can be installed on device to make sound warning or alarm; buttons can be installed on device as user input device for entering command to MCU/DSP, the buttons design will be based on the customized function by manufacturer.
